(19) United States
(12) Patent Application Publication
(10) Pub. No.: US 2014/0323186 A1
(43) Pub. Date: Oct. 30, 2014

(54) PROTECTIVE GUARDS FOR ELECTRONIC DEVICES

(71) Applicant: A&G Merchandise LLC, Woodbridge, VA (US)

(72) Inventors: George BOOSALIS, Woodbridge, VA (US); Agapios Papadamantiou, Woodbridge, VA (US)

(73) Assignee: A&G Merchandise LLC, Woodbridge, VA (US)

(21) Appl. No.: 14/253,438

(22) Filed: Apr. 15, 2014

(30) Foreign Application Priority Data
Apr. 25, 2013 (GR) 20130100252

(51) Int. Cl. G06F 1/16; H04B 1/38; A45C 11/00

(52) U.S. Cl. CPC G06F 1/1613; A45C 11/00; H04B 1/3888; A45C 2011/002; A45C 2011/003
USPC 455/575.8; 206/521; 206/590; 361/679.55

(57) ABSTRACT

A protective guard or set of protective guards for an electronic device may be provided. The protective guard may include sheet of impact absorbing material having a first surface and a second surface opposite the first, and an attachment mechanism provided on the second surface. The protective guard may be configured to be attached to an electronic device via the attachment mechanism.

### PRIORITY CLAIM

This application claims priority to Greek patent application no. 20130100252 filed Apr. 25, 2013 titled ANTI-SLIP ADHESIVE PROTECTIVE GUARDS FOR PORTABLE ELECTRONIC DEVICES, the entire contents of which are hereby incorporated by reference.

### BACKGROUND

Portable electronic devices such as laptops, mobile phones, memory storage devices (e.g. tablets, smart phones, mp3 players), and the like may be vulnerable to damage over time. Conventional protective cases for these devices may be known in the market. These protective cases may protect the device from the damages of everyday use, but they alter the device's shape and size due to their bulk. They are typically made of hard plastic or other similar materials.

Additionally, decorative stickers for portable devices may also be known in the market. These stickers do not add substantial bulk or thickness onto the device, but they are strictly decorative and they do not offer any protection against damage to the device.

Accordingly, a need may exist for protective guards that may protect a portable electronic device against damage without adding substantial bulk or thickness to the device.

### SUMMARY

In one exemplary embodiment, a protective guard for an electronic device may be provided. The protective guard may include sheet of impact absorbing material having a first surface and a second surface opposite the first, and an attachment mechanism provided on the second surface. The protective guard may be configured to be attached to an electronic device via the attachment mechanism.

In another exemplary embodiment, a set of protective guards for an electronic device may be provided. The set of protective guards may include a number of sheets of impact absorbing material. Each sheet may have a first surface and a second surface opposite the first, and an attachment mechanism provided on the second surface. Each sheet may further be configured to be attached to a respective surface of an electronic device via the respective attachment mechanism.

In yet another exemplary embodiment, a system for protecting an electronic device may be provided. The system may include an electronic device having a number of surfaces and at least one feature such that a user may interact with the at least one feature. The system may include two or more protective guards, and each protective guard may include a sheet of shock absorbing material having a first surface and a second surface opposed to the first surface. An attachment mechanism may be provided on the second surface of the sheet. The two or more protective guards may be attached to respective surfaces of the electronic device via the respective attachment mechanisms.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

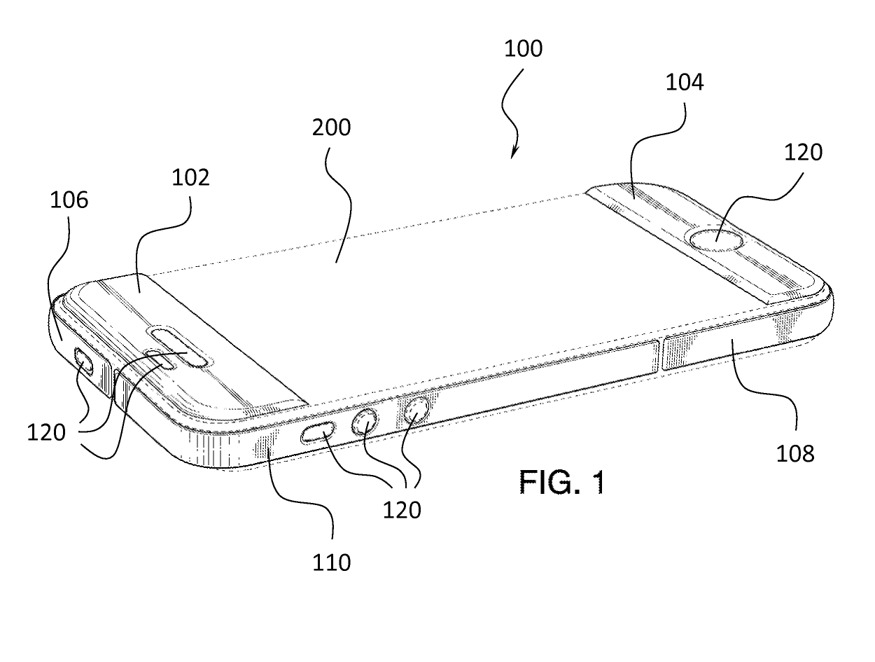

Exemplary FIG. 1 may show a set of protective guards from a front perspective.

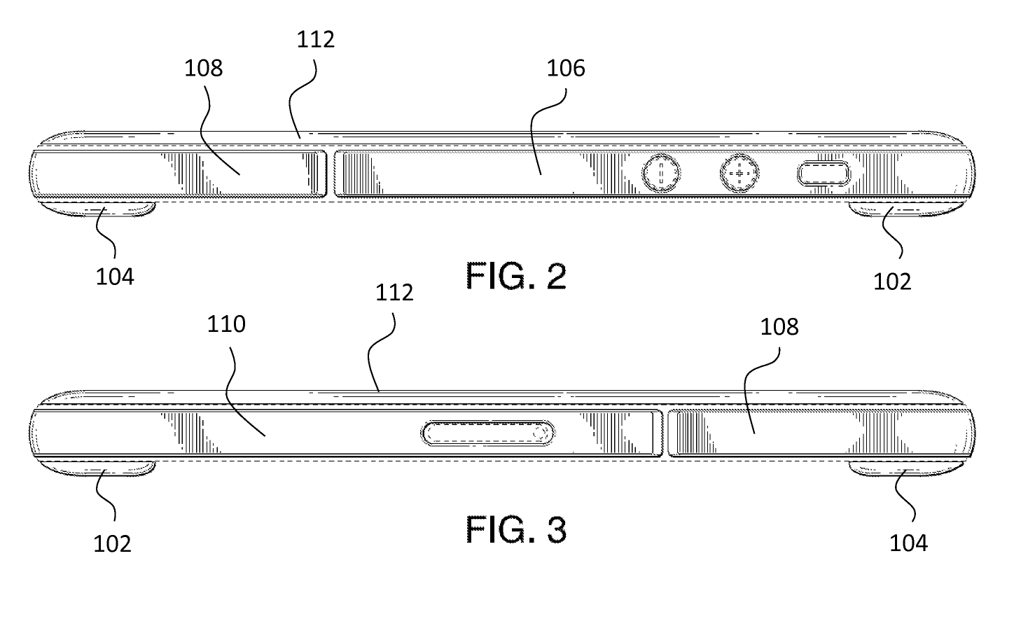

Exemplary FIG. 2 may show a side view of set of protective guards.

Exemplary FIG. 3 may show a side view of a set of protective guards.

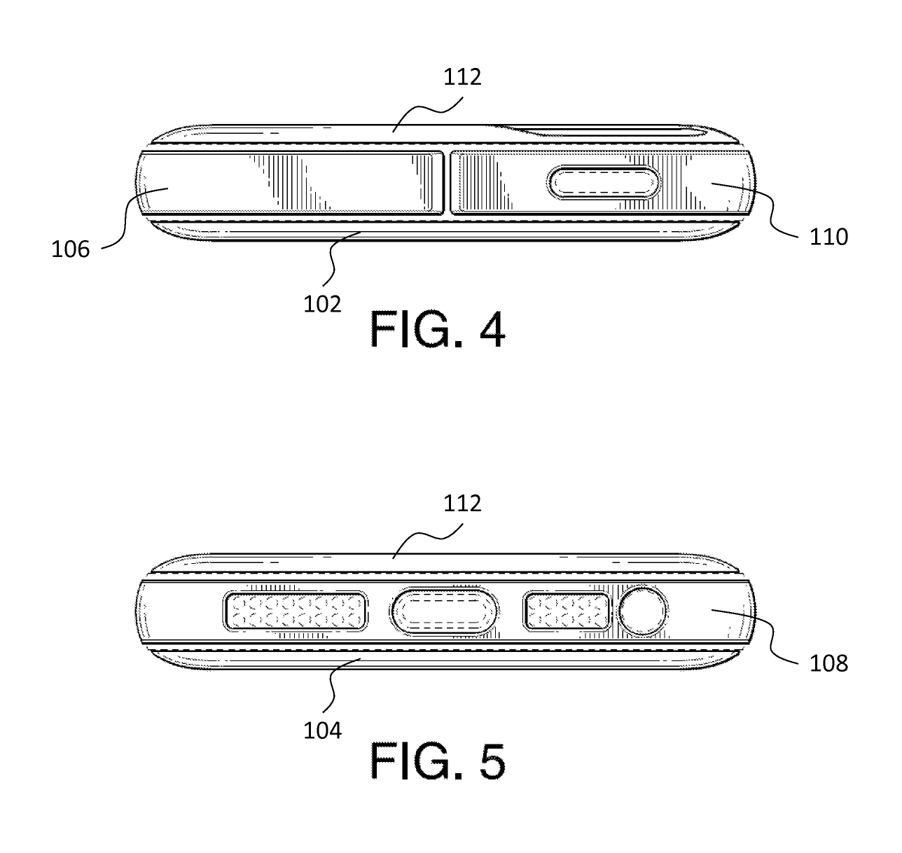

Exemplary FIG. 4 may show a top view of a set of protective guards.

Exemplary FIG. 5 may show a bottom view of a set of protective guards.

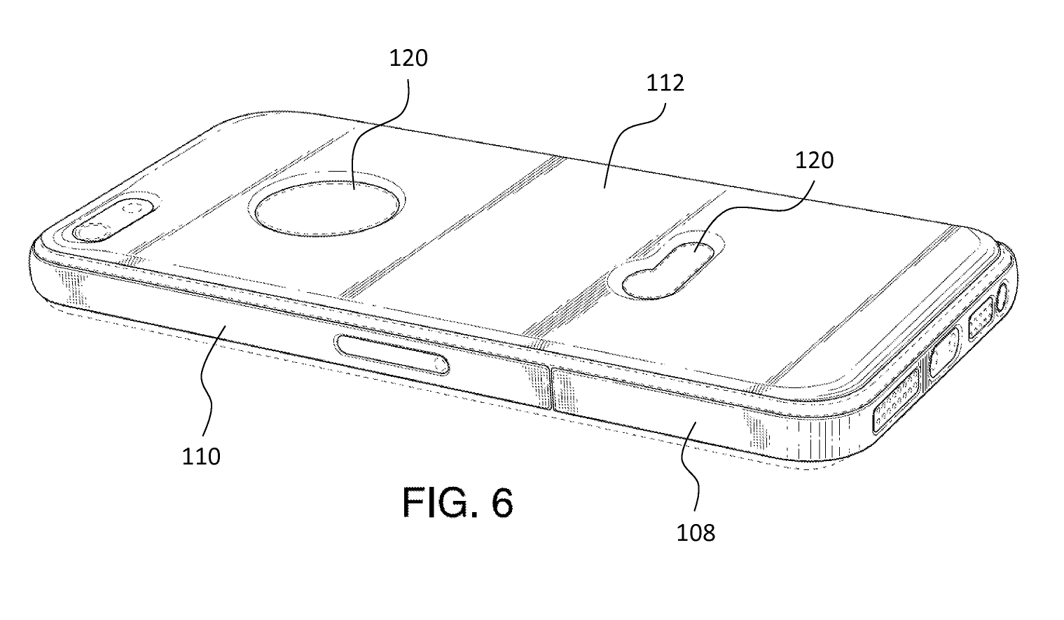

Exemplary FIG. 6 may show a set of protective guards from a rear perspective.

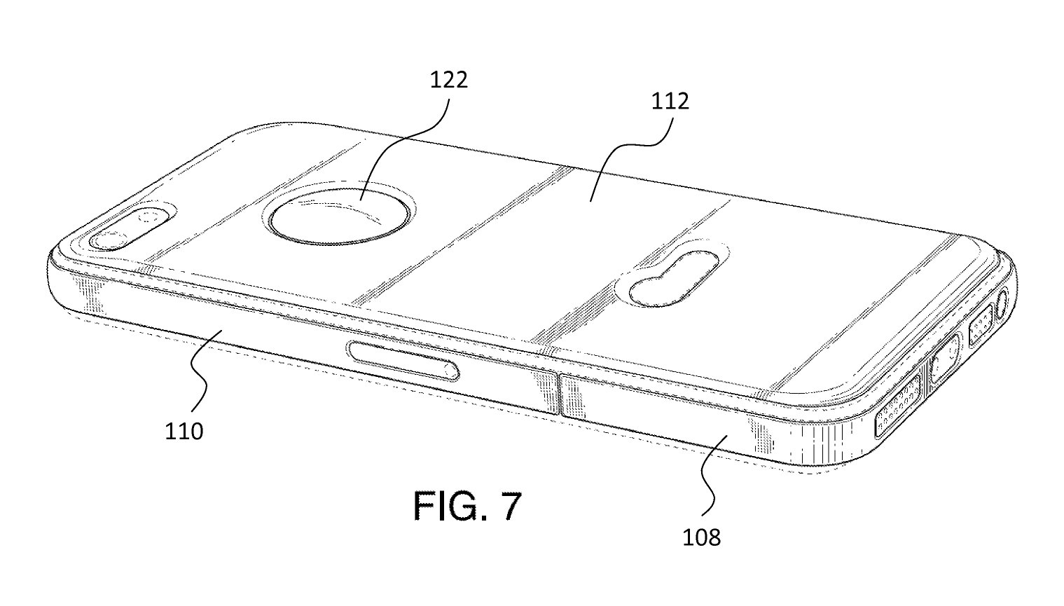

Exemplary FIG. 7 may show a set of protective guards from a rear perspective.

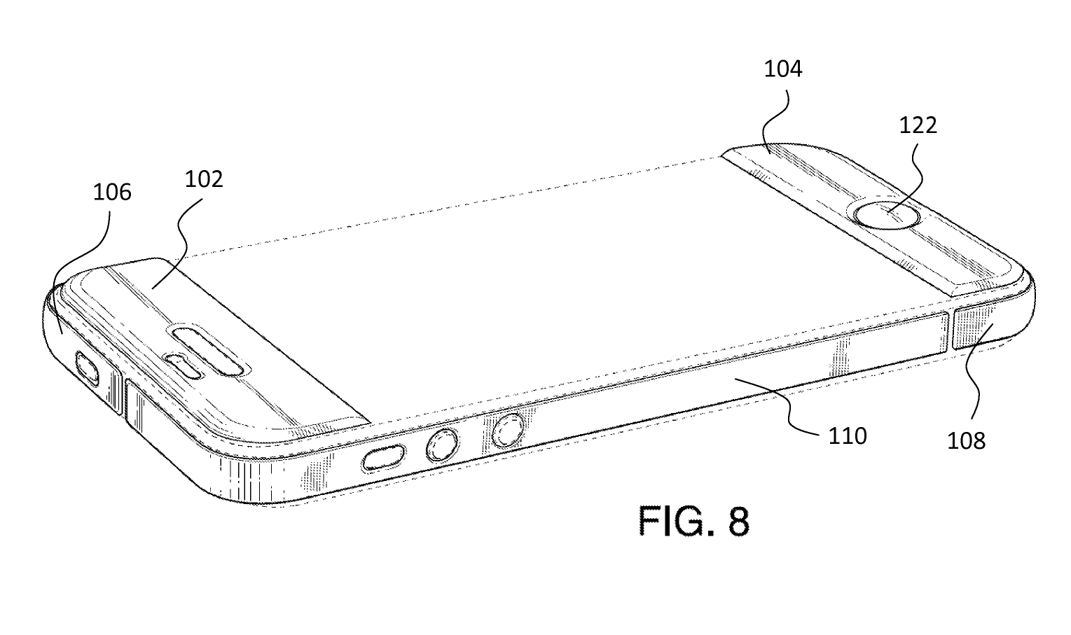

Exemplary FIG. 8 may show a set of protective guards from a front perspective.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Referring to FIGS. 1-8, the set of protective guards may be referred to generally by reference numeral 100. An electronic device may be referred to generally by reference numeral 200.

A set of protective guards 100 may include one or more guards wherein each guard may be defined by a sheet of impact absorbing material having a first surface and a second surface opposite the first, and an attachment mechanism provided on the second surface. The impact absorbing material may include gels, polymers, plastics, rubbers or the like. The impact absorbing material may also be a gripping or anti-slip material such that the first surface of the protective guard may be affixed vertically to a surface while the second surface is attached to the electronic device.

The protective guards 100 may be made of polyurethane epoxy resin that is poured in a liquid heated form onto an adhesive base which may be plain or have a printed pattern. The adhesive base may be cut to specific dimensions depending upon the electronic device that it is intended for. After the above procedure is completed, the polyurethane epoxy resin may cure for 12 to 36 hours to form a transparent, flexible 3-dimensional shock absorbent gel surface which may be coupled to or integral with the adhesive base. So formed, the protective guards 100 may be applied on and off of an electronic device 200 without leaving any residue on the device 200.

The exemplary embodiment of FIG. 1 includes six protective guards, but the number and arrangement of the guards may be modified to meet design parameters as will be understood by those skilled in the art. The exemplary embodiment of FIG. 1 includes two front guards: top guard 102 and bottom guard 104. There are three side panel guards 106, 108 and 110. Additionally, there is a back guard 112 as best seen in FIGS. 6 and 7. The protective guards 100 may be sized and arranged such that they do not contact or overlap with one another, and portions of the electronic device 200 may be visible between each of the protective guards 100 when the set of protective guards 100 are coupled to the electronic device 200.

Each guard may be substantially planar with a first surface configured to face outward away from the electronic device and a second surface configured to face inwardly to abut an outer surface of the electronic device. The inwardly facing second surface may include an attachment mechanism by which it may couple to an outer surface of the electronic device. This attachment mechanism may include an adhesive that is distributed across the inwardly facing second surface. The adhesive may be distributed across the substantial entirety of the second surface. Other attachment means may be provided such as hook and loop fasteners, clips, screws, brackets, or the like.

The electronic device 200 may be, for example, a mobile phone, a tablet, a camera, a laptop, a desktop, or the like. The electronic device 200 may have one or more external features that may allow a user to interact with the electronic device 200. For example, external features may include displays, buttons, switches, cameras, microphones, speakers, lights, lenses or the like.

The protective guards 100 may include one or more apertures 120 extending through the sheet of impact absorbing material. The apertures 120 may be arranged such that they may fit over one or more external features provided on the electronic device 200, allowing a user to view, access or interact with the external features through the apertures. Each aperture 120 may be sized and shaped to substantially match or correspond to an outer perimeter of an external feature on the electronic device 200.

Additional protective guards 122 may be provided within one or more of the apertures 120. Each protective guard 122 may be sized and shaped to match a respective aperture 120. Since each aperture 120 may be sized and shaped to match a respective external feature of the electronic device 200, each protective guard 122 may correspond in size and shape to an external feature of the electronic device 200. A protective guard 122 may be positioned such that it may adhere to an external feature (e.g. a button, switch, or other interactive element). In this manner, a user may actuate or interact with the external feature by contacting the protective guard 122.

The protective guards 100 may be relatively thin so as to provide adequate impact and scratch protection without adding significant weight or bulk to the electronic device. The protective guards 100 may have a thickness from the first surface to the second surface that measures between approximately 0.5 mm and 4.0 mm. The thickness may be less than 3 mm, less than 2.5 mm, less than 2 mm, less than 1.5 mm or less than 1 mm. The edges of each protective guard may be tapered, beveled or rounded to provide ergonomic contours for a user's grip. The edges around the apertures may be similarly beveled or rounded. The tapered, beveled or rounded edges may additionally allow for easier interaction with an external feature. In exemplary embodiments, such as those having a camera or light aperture, the tapered, beveled or rounded edges may additionally improve a viewing angle of the external feature.

As shown in FIGS. 1-8, each protective guard 100 may be attached to a respective surface of an electronic device 200 via a respective attachment mechanism. One or more of the guards 100 may have differing dimensions or shapes that may correspond to differently sized and shaped surfaces of the electronic device 200, and may further have differing aperture arrangements that may correspond to differing features on the electronic device 200. One or more of the protective guards may have a perimeter that may be substantially similar to the perimeter of the electronic device surface to which the respective protective guard 100 corresponds. One or more of the protective guards may be sized such that it may have an area slightly less than the area of the electronic device to which the respective protective guard corresponds.

The electronic device 200 may be a mobile phone 200 having six surfaces, and the set of protective guards 100 may include six protective guards 100 that collectively cover a substantial majority of five of the six mobile phone surfaces. The mobile phone 200 may include a visual display on a front surface, and the protective guards 100 may substantially cover the front surface except for the visual display wherein the visual display is substantially uncovered.

In some exemplary embodiments, the various pieces of the protective guards may have a uniform color or pattern. In other exemplary embodiments, the various pieces of the protective guards may have differing colors or patterns. In such embodiments, the different colored or patterned pieces may be interchangeable to create a desired combination of colors or patterns.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A protective guard for an electronic device comprising:
a sheet of impact absorbing material having a first surface and a second surface opposite the first, and an attachment mechanism provided on the second surface;
wherein the protective guard is configured to be attached to an electronic device via the attachment mechanism.

2. A protective guard as recited in claim 1, wherein the attachment mechanism comprises an adhesive that is distributed across the second surface.

3. A protective guard as recited in claim 2, wherein the sheet of impact absorbing material is substantially planar.

4. A protective guard as recited in claim 3, wherein the sheet of impact absorbing material has a thickness defined as a distance between the first surface and the second surface wherein the thickness is less than 2.5 mm.

5. A protective guard as recited in claim 3, wherein the sheet of impact absorbing material has a thickness defined as a distance between the first surface and the second surface wherein the thickness is less than 1.5 mm.

6. A protective guard as recited in claim 3, wherein the protective guard comprises one or more apertures wherein the apertures are configured to allow access to features on an electronic device when the protective device is attached to the electronic device.

7. A protective guard as recited in claim 6, wherein the protective guard comprises an anti-slip material such that the first surface of the protective guard may be affixed vertically to a surface while the second surface is attached to the electronic device.

8. A set of protective guards for an electronic device comprising:
a plurality of sheets of impact absorbing material, each sheet having a first surface and a second surface opposite the first, and an attachment mechanism provided on the second surface;
wherein each sheet is configured to be attached to a respective surface of an electronic device via the respective attachment mechanism.

9. A set of protective guards as recited in claim 8, wherein each attachment mechanism comprises an adhesive that is distributed across the respective second surface.

10. A set of protective guards as recited in claim 9, wherein each sheet of impact absorbing material is substantially planar.

11. A set of protective guards as recited in claim 10, wherein at least two of the plurality of sheets comprises one or more apertures the apertures are configured to allow access to features on an electronic device when the protective device is attached to the electronic device.

12. A set of protective guards as recited in claim 11, wherein at least two of the plurality of sheets have differing dimensions or shapes, and wherein the at least two sheets have differing aperture arrangements configured to correspond to differing features on an electronic device.

13. A system for protecting an electronic device against damage comprising:
an electronic device having a plurality of surfaces and at least one feature wherein a user may interact with the at least one feature;
two or more protective guards, wherein each protective guard comprises a sheet of shock absorbing material having a first surface and a second surface opposed to the first surface, and an attachment mechanism provided on the second surface;
wherein the two or more protective guards are attached to respective surfaces of the electronic device via the respective attachment mechanisms.

14. The system of claim 13 wherein each attachment mechanism comprises an adhesive that is distributed across the respective second surface.

15. The system of claim 14 wherein each sheet of impact absorbing material is substantially planar.

16. The system of claim 15, wherein at least one of the protective guards comprises one or more apertures that are positioned over the one or more features of the electronic device such that a user may interact with the one or more features through the one or more apertures.

17. The system of claim 16, wherein the at least two protective guards are sized and shaped differently such that they correspond to at least two differently sized and shaped surfaces of the electronic device.

18. The system of claim 17, wherein each protective guard has a perimeter that is substantially similar to the perimeter of the electronic device surface to which the respective protective guard corresponds, and each protective guard is sized such that it has an area that is slightly smaller than the area of the electronic device to which the respective protective guard corresponds.

19. The system of claim 18, wherein each protective guard comprises an anti-slip material such that the first surface of one of the protective guards may be affixed vertically to a surface, thereby attaching the electronic device to said vertical surface.

20. The system of claim 18, wherein the electronic device is a mobile phone having six surfaces, and there are six protective guards that collectively cover a substantial majority of five of the six mobile phone surfaces.
